(19) United States
(12) Patent Application Publication
(10) Pub. No.: US 2005/0029354 A1
(43) Pub. Date: Feb. 10, 2005

(54) System associating sets of data into one barcode

(76) Inventors: Didier Frantz, New York, NY (US); Olivier Attia, New York, NY (US); Ashish Muni, Flushing, NY (US)

Correspondence Address: Avi Outmezguine, Fourth Floor, 54 West 39th Street, New York, NY, 10018, US

(21) Appl. No.: 10/885,607

(22) Filed: Jul. 8, 2004

Related U.S. Application Data
(60) Provisional application No. 60/492,305, filed on Aug. 5, 2003.

(51) Int. Cl. G06K 7/10

(52) U.S. Cl. 235/462.01

(57) ABSTRACT

The present invention discloses a system and method for encoding and decoding combination barcodes which contain two or more items of data. Generally, the device encodes a combination barcode by assembling a string of codes associated with each item of data. A barcode is then created from the string of codes by feeding it into a barcode generator. Both one and two-dimensional barcode symbologies may be utilized to create the combination barcode. To decode a combination barcode, a user first scans and uploads the combination barcode to a computer application. The application then identifies the uploaded combination barcodes utilizing a metric and separates the combination barcodes into their constituent parts.

### FIELD OF THE INVENTION

The present invention relates generally to the field of encoding barcodes. More specifically, the present invention discloses a system and method for creating a new barcode from one or more existing sets of data.

### PARENT CASE TEXT

This application claims the benefit of provisional application No. 60/492,305 filed Aug. 5, 2003.

### BACKGROUND OF THE INVENTION

Barcodes have been utilized for identifying and pricing objects for more than thirty years. Most typically, barcodes are used in retail to identify the price of an item of merchandise. For example, a gallon of milk may contain a barcode that, when scanned, will notify the cashier of the price of the milk.

Barcodes are currently available in many different standardized symbologies which include UPC-A, UPC-E, ISBN, RSS-14, RSS-14E, RSS-14L, Interleaved 2 of 5, EAN/JAN-8, EAN/JAN-13, Code 38, Code 39 Full ASCII, Code 128, PDF417, QR Code, and Data Matrix. Each of these symbologies has a set of rules which govern how barcodes are encoded and decoded. The encoding is typically performed utilizing a computer application programmed with each of the rules for the desired symbology. The information to be encoded is entered into the program and the resulting barcode is outputted. The barcode can then be printed or utilized in any similar manner.

The decoding of barcodes is usually accomplished utilizing laser-based scanning devices. However, optical decoding devices are also available as is disclosed in co-pending U.S. Provisional Application No. 60/487,237 entitled “ScanZoom.” Optical decoding technology is designed to operate with any camera-equipped device, either mobile or stationary.

Each barcode utilized in commerce (usually a UPC-A barcode) uniquely identifies one product and one manufacturer. Therefore, if a person wished to purchase fifteen of a certain product, the person would have to scan the individual barcode fifteen times to indicate the quantity desired. This can become particularly burdensome if a person has to scan large quantities of many different products.

Barcodes are also utilized for other purposes than encoding product information. For example, in co-pending U.S. patent application Ser. No. 10/334,800, barcodes are utilized to encode information about trade show participants and different actions. For example, a participant in the trade show may scan one barcode which identifies a user and then another barcode which identifies the user's employer. By scanning the two barcodes in succession, the participant can later view which users worked for which employers.

Based on the aforementioned, there clearly exists a need for a system which enables a user to scan multiple quantities more efficiently. Such a system would greatly increase the speed at which a user could scan multiple quantities of a single barcode.

### SUMMARY OF THE INVENTION

The present invention provides a system and method designed to successfully encode and decode combination barcodes which contain one or more sets of data. To encode a combination barcode, a user first selects a principal item using a software program. Each item has a designated item code associated with it. After this, the user selects the additional data which the user wishes to encode along with the item code. In the preferred embodiment, the user would select a quantity code to encode along with the item code. However, the user may also select other types of codes. For example, a user may also select a size (small, medium, large, etc.) or a color for encoding along with the item code. As another example, the code may relate to a particular action to be performed in connection to the item code such as “Purchase” or “Call tomorrow.” Each of these additional codes also would have a code associated with it similar to the item code.

Once the user has selected all of the sets of data to encode, the application creates a string of codes by starting with the item code and appending each additional code as it was selected by the user. This string of codes is then fed into a barcode encoder which creates a barcode from the data. The barcode may either be one-dimensional or two-dimensional depending upon the requirements of the inputted codes and the user's preferences. The combination barcode may then be printed using a printer or saved for further use.

To decode a combination barcode, a user first scans a combination barcode utilizing a barcode scanner. The barcode scanner may either be a laser-based scanner or any device capable of digitally imaging the combination barcode such as a camera phone, mobile phone with camera attachment, PDA, PDA with camera attachment, Pocket PC, Palm device, laptop, desktop, etc. The preferred optical decoding system and method is described in U.S. Provisional Application No. 60/487,237 entitled “ScanZoom” and U.S. Provisional Application No. 60/511,703 entitled “Server-Side Decoding Process of Image.”

After the barcode has been scanned, the information is uploaded to a computer utilizing a computer application. This computer application can either be a standalone application or the same application that was utilized to encode the barcode. The application searches through the uploaded barcodes and identifies the combination barcodes utilizing a metric. All barcodes which contain more than a certain amount of characters are labeled as combination barcodes.

Once the combination barcodes have been identified, they can be separated into their constituent parts according to the encoding rules. For example, if a combination barcode is detected which contains an item code and a quantity code, the application assigns the decoded quantity to the item which was identified by the item code. Or, if the combination barcode contains an item code which refers to a person and an additional code which refers to a company, the system of the present invention would designate the company as the employer of the person scanned.

Therefore, it is an object of the present invention to provide a software application for creating a combination barcode from one or more sources of data.

It is an additional object of the present invention to provide a software application for creating a combination barcode which contains item data and quantity data.

Another object of the present invention is to provide a software application capable of encoding and decoding combination barcodes.

An additional object of the present invention is to provide a software application which can create barcodes utilizing one or more barcode symbologies.

Yet another object of the present invention is to provide a software application which can correctly decode combination barcodes containing two or more items of data.

These and other objects of the present will be made clearer with reference to the following detailed description and accompanying drawings.

### BRIEF DESCRIPTION OF THE DRAWINGS

FIG. 1 depicts a flowchart of the steps utilized by the software application of the present invention to create a combination barcode.

FIG. 2A depicts an item barcode.

FIG. 2B depicts a sample sheet containing a plurality of quantity barcodes.

FIG. 2C represents a combination barcode made by combining data from the barcodes depicted in FIG. 3A and FIG. 3B.

FIG. 3 depicts a flowchart showing the steps the software application utilizes to decode a combination barcode.

### DETAILED DESCRIPTION OF THE PREFERRED EMBODIMENT(S)

The following presents a detailed description of a preferred embodiment (as well as some alternative embodiments) of the present invention. However, it should be apparent to one skilled in the art that the described embodiment may be modified in form and content to be optimized for a wide variety of situations.

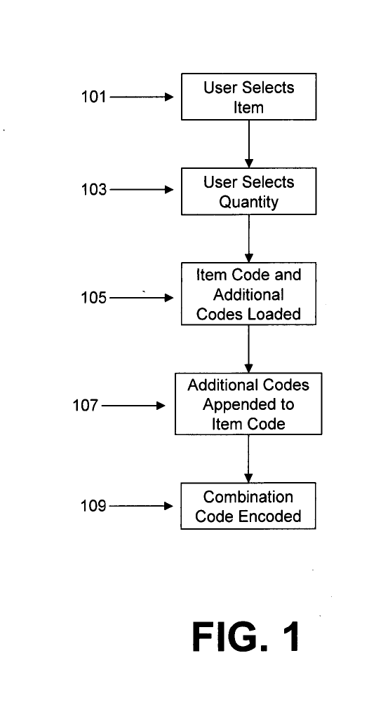

Referring first to FIG. 1, shown is a flowchart depicting the method utilized by the present invention to encode a combination barcode. For simplicity, FIG. 1 depicts the creation of a combination code from an item code and a quantity code. However, it should be obvious to one skilled in the art how the methods of this invention may be extended to create combination barcodes for multiple sets of data.

To encode a combination barcode, a user first selects a principal item using a software program in step 101. Each item has a designated item code associated with it. After this, the user selects the additional data which the user wishes to encode along with the item code. In the preferred embodiment, the user selects a quantity in step 103. However, the user may also select other types of information. For example, a user may also select a size (small, medium, large, etc.) or a color for encoding along with the item code. As another example, the code may relate to a particular action to be performed in connection to the item code such as “Purchase” or “Call tomorrow.” Each of these additional codes also would have a code associated with it similar to the item code.

After the selection of all codes has been accomplished, the software application loads the associated codes into memory in step 105. The application utilizes the loaded codes to create a string of codes by starting with the item code and appending each additional code as it was selected by the user. In this case, the string of codes would start with the item code and be followed by the associated quantity code in step 107. This string of codes is then fed into a barcode encoder which creates a barcode from the data in step 109. The barcode may either be one-dimensional or two-dimensional-depending upon the requirements of the inputted codes and the user's preferences. Some examples of barcode symbologies which may be utilized by the present invention include, but are not limited to, UPC-A, UPC-E, ISBN, RSS-14, RSS-14E, RSS-14L, Interleaved 2 of 5, EAN/JAN-8, EAN/JAN-13, Code 39, Code 39 Full ASCII, Code 128, PDF417, QR Code, Data Matrix, and Optical Intelligence 2D. The combination barcode may then be printed using a printer or saved for further use.

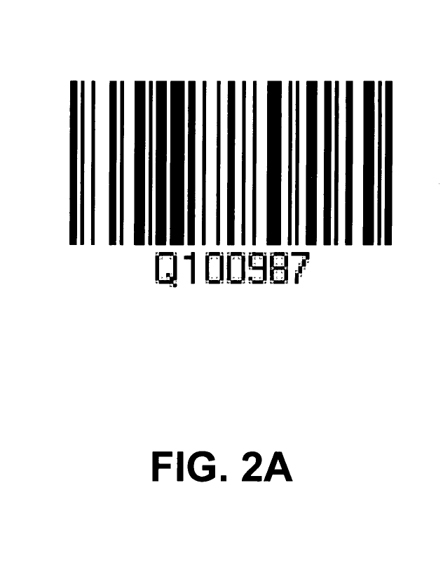

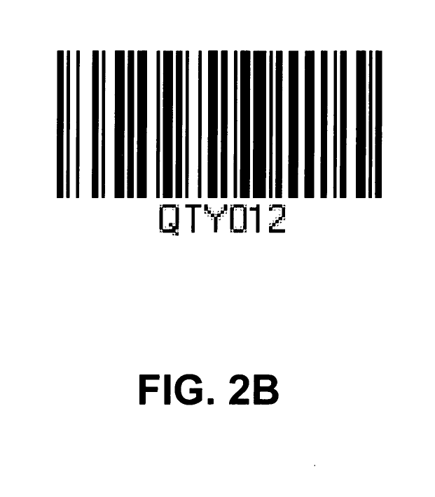

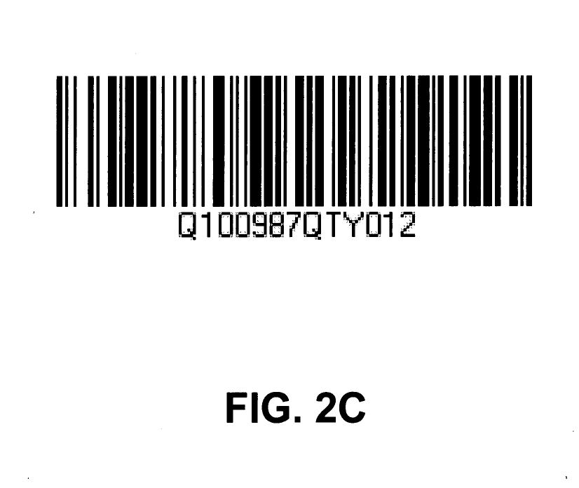

Now, the encoding of a combination barcode will be demonstrated with reference to FIG. 2A, FIG. 2B, and FIG. 2C. A sample item code and its encoded barcode is shown in FIG. 2A. The value of the item code is Q100987 and the barcode is encoded utilizing Code 128.

A sample quantity code and its encoded barcode is shown in FIG. 2B. The value of the quantity code is QTY012 which refers to a quantity of twelve. If a user were to select the item code and quantity code shown in FIG. 2A and FIG. 2B, the application would form the character string Q100987QTY012 and encode it utilizing Code 128. The resulting combination barcode is depicted in FIG. 2C along with its encoded value.

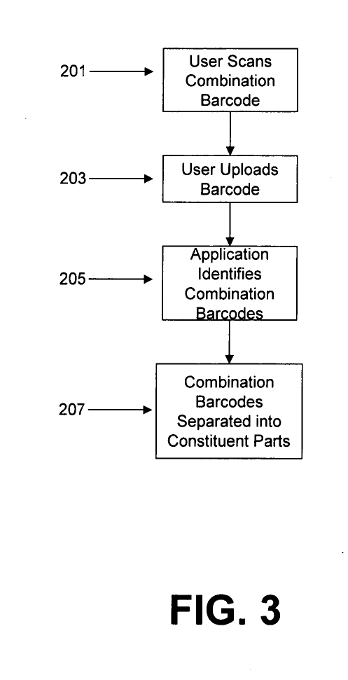

Referring next to FIG. 3, shown is a flowchart depicting the method utilized by the present invention to decode a combination barcode. To decode a combination barcode, a user first scans a combination barcode utilizing a barcode scanner in step 201. The barcode scanner may either be a laser-based scanner or any device capable of digitally imaging the combination barcode such as a camera phone, mobile phone with camera attachment, PDA, PDA with camera attachment, Pocket PC, Palm device, laptop, desktop, etc. The preferred optical decoding system and method is described in U.S. Provisional Application No. 60/487,237 entitled “ScanZoom” and U.S. Provisional Application No. 60/511,703 entitled “Server-Side Decoding Process of Image.”

After the image has been scanned, it is uploaded to a computer utilizing a computer application in step 203. This computer application can either be a standalone application or the same application that was utilized to encode the barcode. The application searches through the uploaded barcodes and identifies the combination barcodes utilizing a metric. All barcodes which contain more than a certain amount of characters or contain certain unique identifiers are labeled as combination barcodes in step 205.

Once the combination barcodes have been identified, they can be separated into their constituent parts according to the encoding rules in step 207. For example, if a combination barcode is detected which contains an item code and a quantity code, the application assigns the decoded quantity to the item which was identified by the item code.

While the foregoing embodiments of the invention have been set forth in considerable detail for the purposes of making a complete disclosure, it should be evident to one skilled in the art that multiple changes may be made to the aforementioned description without departing from the spirit of the invention.

1. A method of encoding a combination barcode comprising the steps of:
selecting an item associated with an item code;
selecting a quantity associated with a quantity code;
loading said item code and quantity code into a software application;
appending said quantity code to said item code to create a combination code; and
encoding said combination code utilizing a barcode encoder.

2. A method of encoding a combination barcode according to claim 1 wherein the quantity code is of the form QTYXXX where XXX refers to the represented quantity.

3. A method of encoding a combination barcode according to claim 1 wherein said combination barcode is encoded from a barcode symbology library including, but not limited to, UPC-A, UPC-E, ISBN, RSS-14, RSS-14E, RSS-14L, Interleaved 2 of 5, EAN/JAN-8, EAN/JAN-13, Code 38, Code 39 Full ASCII, Code 128, PDF417, QR Code, and Data Matrix.

4. A method of decoding a combination barcode comprising the steps of:
scanning a combination barcode with a barcode scanner;
uploading said scanned combination barcode utilizing a software application;
identifying said combination barcodes; and
separating said combination barcode into its constituent parts.

5. A method of decoding a combination barcode according to claim 4 wherein the barcode scanner is a laser-based barcode scanner.

6. A method of decoding a combination barcode according to claim 4 wherein the barcode scanner utilizes optical decoding techniques.
